(19) United States
(12) Patent Application Publication
(10) Pub. No.: US 2012/0085984 A1
(43) Pub. Date: Apr. 12, 2012

(54) Gravity energy storage and generating device

(76) Inventor: Arvind A. Daya, Fayetteville, GA (US)

(21) Appl. No.: 12/924,961

(22) Filed: Oct. 8, 2010

(51) Int. Cl. B66D 1/36

(52) U.S. Cl. 254/338

(57) ABSTRACT

The Gravity energy storage and generating device, main object of the invention is to provide improved mechanical energy storage and release device comprising of the wound and weight energy storing elements. The said device installed in the ground or above where gravity plays a vital role in generating and storing, a large stainless steel encased concrete piston mass that fits in a long cylinder. Both end of the said piston is sealed with two rubber seal ring on the top of the piston and the bottom of piston against the cylinder walls. The cylinders top and the bottom is completely sealed (air tight). The piston's resting point known as first position at the bottom of the cylinder is rubber padded cushion with springs attached to soften the fall of the piston during generating electricity. As the steel cables that is attached at the top of the heavy said piston is pulled up by mean of pulleys. The concrete piston reaches the top also known as second position, you have three forces of energy that is been applied to the piston, gravity, vacuum and air pressure. As the piston descent downwards the shaft attached to the gearbox starts turning, whereby turning the generator.

### FIELD OF INVENTION

The invention relates to improved mechanical energy storage and release system of comprising wound energy storage element. More particularly, the invention relates to an improved system for storing and generating energy. This device can be attached to wind mills, or in form of exercise bicycle and any form of energy producing device that has momentum.

### BACKGROUND OF THE INVENTION

There exit numerous prior related devices which have been attempted to store energy. To date, such systems have failed to be adopted. Weight as energy storage devices have been extensively used in commercial lifts for counter balance. Large construction cranes to counter balance lifting heavy loads.

Accordingly, the present invention improves upon the art in providing an efficient and low maintenance of mechanical energy and release devices that capable of being recharged anywhere, anytime repeatedly, thereby extending the usability. This device primely uses energy storing element in form of gravity. With the present system of invention there is three form of energy is stored in this device that can be used to generate electricity; Gravity, vacuum and air pressure.

### SUMMARY OF THE INVENTION

The main object of the invention is to provide improved mechanical energy storage and release device comprising of the wound and weight as energy storing elements. Energy storage device installed in the ground or above where gravity plays a vital role in generating and storing, a large concrete piston mass that fits in a long cylinder as required. Both end of the concrete piston is sealed with two rubber seal ring on the top of the said piston and the bottom of concrete piston. The cylinders top and the bottom is completely sealed (air tight). The piston's resting point or starting point is at the bottom of the cylinder. At the bottom of the cylinder below the concrete piston rest position there is rubber padded cushion with springs attached to soften the fall of the piston during generating. As the steel cables that is attached at the top of the heavy concrete piston is pulled up by mean of pulleys. The concrete piston reaches the top also known as the second position at that point computer assisted monitor and controlled programs not shown who guides and monitor the entire operation, the piston starts descending as the piston goes down generating electricity and reaches the bottom at the same time the sprag clutch allows the generator to continue rotating with the flywheel on the generator, you have three forces of energy that is been applied to the piston.

The first one been the gravity (weight) acting on the mass load to take the load to the bottom. Second been the air pressure built up while the piston been pulled up by cables since the top of the cylinder is sealed and the piston has sealing ring.

Thirdly the vacuum that is created while the sealed piston is drawn up to the top of the cylinder. The invention created a huge force on the piston as the piston is been drawn up all the energy used can be stored and be generated in form of electricity. In an event of mishap for safety the entire chamber is sealed.

Other objects and advantages of the invention will be apparent from reading the descprition and viewing the drawings herewith.

### BRIEF DESCRIPTION OF THE DRAWING

FIG. 1 is a diagrammatically cross section drawing of the energy storage and releasing mechanism.

FIG. 2 depicts of cross section of clutch assembly.

### DETAIL DESCRIPTION OF THE PREFERRED EMBODIMENT

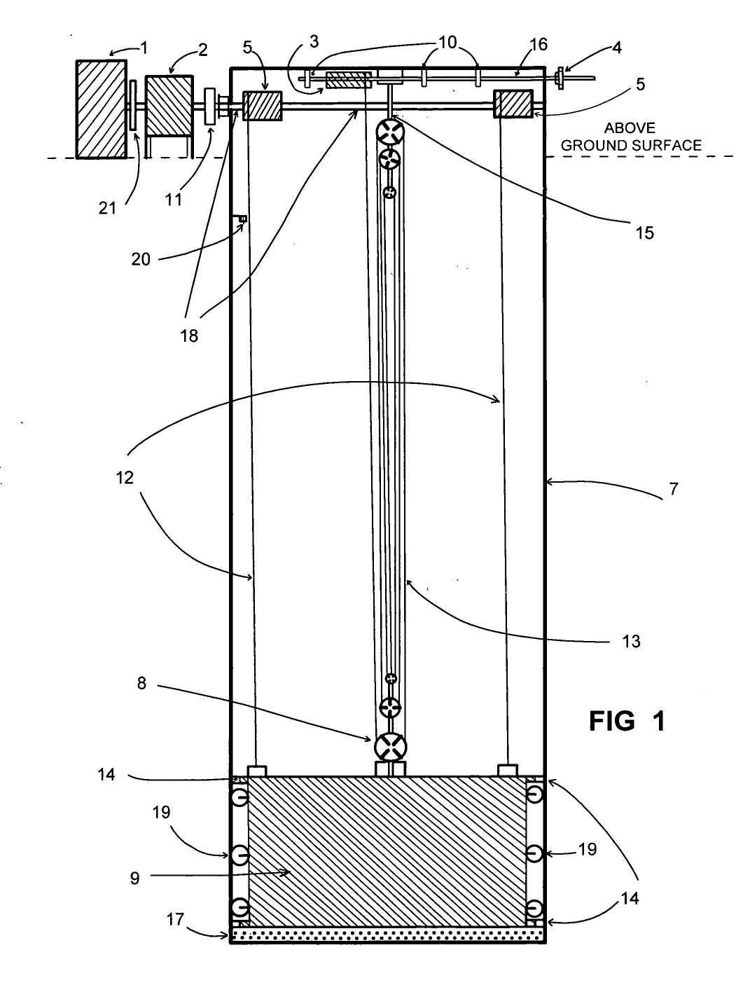

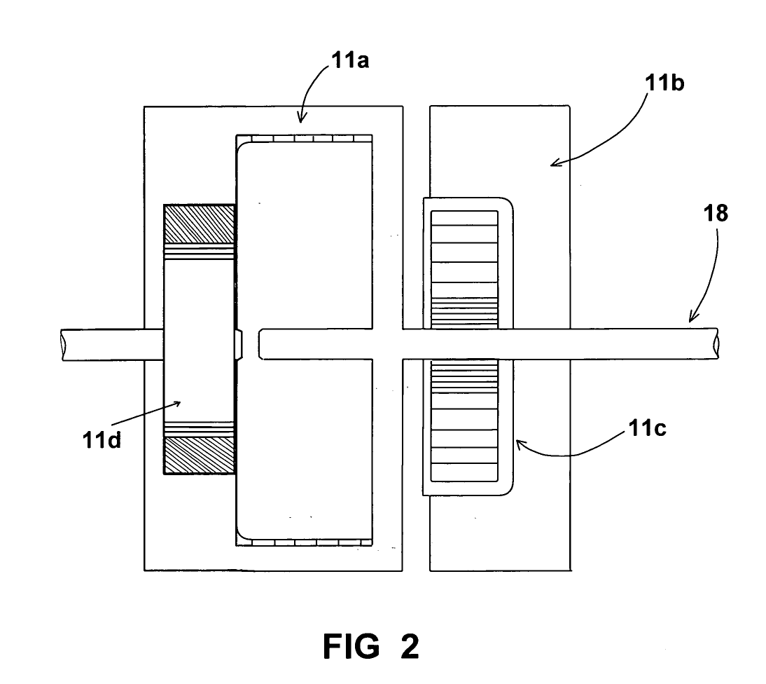

Referring now to the present invention represents energy storage and generating device designated by the numeral 10 depicted in FIG. 1-2. A simple and basic structure of the energy storage and generator is shown in cross section view in FIG. 1, which can be installed above ground as well below ground. A large cylinder 7 installed in the ground with a heavy piston type stainless steel encased concrete filled slab 9, inserted in the said cylinder. The up and down movement of the piston 9, on the inner cylinder walls of the cylinder 7, is guided with wheels 19, on the piston at tree or four locations which are spaced out evenly on the walls of the cylinder 7, The piston's 9, upper and the lower diameters are fitted with rubber seals 14. The heavy piston's 9 first position is at the bottom of the cylinder, where the piston 9. rest on a rubber pad cushioned by springs 17. The piston 9, is pulled up very slowly with an aid of a pulley system 8, which is used to lift heavy loads. The pulley system is operated with a cable reel 3, which under constant power spring(not shown) pressure to maintain tension on the steel cable 13, that is supported by bearing blocks 10, on which steel cable 13, is drawn in when rotated by the shaft 16, by other sources externally. Just before clutch 4, is applied to turn the shaft 16. The system verifies the piston 9, is at the bottom and clutch 11a, in FIG. 2 disengaged which is attached to the gearbox 2. Shaft 18, outside the cylinder is also equipped with a power spring 11c, the said power spring housing is attached to the exterior of the cylinder to maintain tension on the steel cables 12, on reels 5, at all times. Once the said piston reached the second position, upper max limit where a limit switch 20, has triggered is when the clutch 11a, (shown in FIG. 2) is locked and applied to the gearbox 2, and generator 1. Once this stage of the operation in completed and verified the clutch 4 is released at that point the power spring in reel 3, maintain the tension on the steel cable 13, whereby the piston 9, start to go down due to massive force created by gravitational, vacuum and compressed air. Thus gearbox 2, starts to turn, in-turn turns the generator 1, By having seals 14, lubricated on the piston, 9, furthermore the cylinder 7, is completely sealed thus creating a massive force, it is also understood that if seals are not installed or worn out and damaged this energy storage device will store gravitationally. This massive downwards moment is the energy stored which is turning cable reel 5, whereby shaft 18, is turning and since clutch 11a, is applied the gearbox 2, is turning the generator 1, thus generating electricity. Once the piston 9, returns to the first position the landing is softened and stopped by rubber pad and springs 17, the generator keep turning because of momentum, this situation is maintained by the sprag clutch 11d, and the flywheel 21, attached to the generator. Thereafter the entire operation is repeated when information is processed by the computer.

While this invention has been explained with reference to the structure disclosed herein, it is not confined to the details as set forth and this application intended to cover any modifications and changes as may come within the scope of the following claim. The method of storing energy for use in powering a mechanism.

What is claimed:

1. A gravity energy storage and generating device comprising; a piston and pulley assembly for selectively storing and releasing energy to power an apparatus as in FIGS. 1 and 2 including;
a main supporting cylinder structure's shape could be round, square, rectangular or triangular;
a piston with wheel to be guided on rails;
a plurality of pulley system of lifting the piston;
a plurality of steel cables;
a plurality of steel cable wounding reels

2. A gravity energy storage and generating device as in claim 1 wherein the said cylinder been sealed (air tight);

3. A gravity energy storage and generating device as claim in anyone of the claims 1 to 2 wherein the piston is filled of heavy material such as concrete, steel, etc.

4. A gravity energy storage and generating device as claim in anyone of the claims 1 to 3 wherein the piston is fitted with or without seals;

5. A gravity energy storage and generating device as claim in anyone of the claims 1 to 4 wherein the upward movement of the said piston is initiated by the clutch assembly located outside the cylinder by external force;

6. A gravity energy storage and generating device as claim in anyone of the claims 1 to 5 wherein the upward travel of the said piston is by the rotation the cable reels, pulleys and cables.

7. A gravity energy storage and generating device as claim in anyone of the claims 1 to 6 wherein the shaft of the cable reel of claim 6 is also connected to a power spring to maintain tension on the cables;

8. A gravity energy storage and generating device as claim in anyone of the claims 1 to 7 wherein the steel cable as in claim 6 is in the center of the cylinder wherein operated by pulleys and steel cables;

9. A gravity energy storage and generating device as claim in anyone of the claims 1 to 8 wherein one set of the pulleys as in claim 6 are connected to the center of the piston

10. A gravity energy storage and generating device as claim in anyone of the the claims 1 to 9 wherein the other set of pulleys as in claim 6 are connected at the top reinforced lid of the cylinder;

11. A gravity energy storage and generating device as claim in anyone of the claims 1 to 10 wherein the said piston is lifted by the rotation of the steel cable and the pulleys as in claim 9 in the center of the cylinder;

12. A gravity energy storage and generating device as claim in anyone of the claims 1 to 11 wherein the top outer two reels are further connected to a common shaft which turns the gearbox externally;

13. A gravity energy storage and generating device as claim in anyone of the claims 1 to 12 wherein the one end of each outer two cables as in claim 1 are connected to reel respectively.

14. A gravity energy storage and generating device as claim in anyone of the claims 1 to 13 wherein the other end of the each cable of the two outer cables as in claim 12 are connected to the said piston on the outer perimeter of the piston;

15. A gravity energy storage and generating device as claim in anyone of the claims 1 to 14 wherein the shaft on the two reels on top section of the cylinder is connected to a clutch assembly in FIG. 2 where the spag clutch is further connected to the flywheel and gearbox;

16. A gravity energy storage and generating device as claim in anyone of the claims 1 to 7 wherein the clutch assembly in FIG. 2 is attached with a power spring to rewind and maintain tension on cables during energy storing process.
